(19) United States
(12) Patent Application Publication
(10) Pub. No.: US 2006/0265962 A1
(43) Pub. Date: Nov. 30, 2006

(54) Snap-on barrier panels for automobile door panel assemblies

(76) Inventor: Jay Winborn, Berkley, MI (US)

Correspondence Address: BUTZEL LONG, 350 SOUTH MAIN STREET, SUITE 300, ANN ARBOR, MI, 48104, US

(21) Appl. No.: 11/240,020

(22) Filed: Sep. 30, 2005

Related U.S. Application Data
(63) Continuation-in-part of application No. 11/134,942, filed on May 23, 2005.

(51) Int. Cl. B60J 5/04

(52) U.S. Cl. 49/502

(57) ABSTRACT

A molding apparatus for forming engaging structures in vehicle door panels which engaging structures have base portions and over-hanging or under cut edges. The molding apparatus includes an engaging structure mold base for forming the base portion of a molded engaging structure and a movable tip coupled to the engaging structure mold base for movement between a first position for forming an over-hanging or under cut in the molded engaging structure and a second position for releasing the molded engaging structure from the molding apparatus.

### RELATED APPLICATION

This application is a Continuation-In-Part of U.S. patent application Ser. No. 11/134,942, filed May 23, 2005 to which priority is claimed under 35 U.S.C. §120 and of which the entire specification is hereby expressly incorporated by reference.

### TECHNICAL FIELD

The present invention relates to vehicle door assemblies which include barrier panels that prevent the ingress of water, dust and air into vehicle passenger compartments and provide acoustic and thermal insulation for vehicle door assemblies. More particularly, the present invention relates snap-on barrier panels that are provided with engaging structures by which the barrier panels can be aligned and attached to door panels. Even more particularly, the present invention relates to methods of manufacturing the snap-on barrier panels.

### BACKGROUND ART

Automobile door assemblies generally include an exterior metal panel skin that is joined to an inner wall panel along the respective edges of the panels. Together, the exterior panel and the inner wall panel form a cavity within which the door window may be lowered. This cavity may also contain window regulating equipment, door locks, sound speakers, air bag systems, and the like. The inner wall panel is covered with a rigid or semi-rigid interior trim panel formed of a cloth-like or plastic trim material which serves as the interior passenger compartment door panel.

Door panel assemblies are susceptible to the ingress of water which can enter into door cavities through the openings through which the door windows slide. Holes are generally formed in the bottom of door panel assemblies to allow any water that enters the door cavities to drain out. However, as water enters door cavities and runs down along the inner wall panel toward the drain holes, it can seep into and through the interior trim panel unless a barrier of some type is provided in the assembly.

In order to protect the interior trim panel from becoming wet and possibly stained or otherwise damaged, it is common to attach a panel liner over the inner wall panel beneath the interior trim panel. Such panel liners are often made of a treated paper material or can comprise a thin plastic film. The panel liner functions to deflect any water entering the door cavity so that the water runs down the liner to the bottom of the door cavity without contacting the interior trim panel.

Liners used in door panel assemblies are typically provided with beads of adhesive which are primarily provided to create a water tight seal between the liners and the adjacent door panels. In order to protect the adhesive beads, a release sheet is secured to the liners over the adhesive beads. The release sheet has to be removed when the liner is applied to an inner wall panel of a door. During the assembly of door assemblies the adhesive beads can frustrate the alignment of the liners with respect to the door panels when the adhesive prematurely contacts and sticks to the door panels.

Inner trim panels of door assemblies together with liners are typically attached to door panels by a plurality of push-in fasteners that are commonly referred to as “Christmas trees.” The push-in fasteners extend outward from the outboard side of the inner trim panels and are spaced apart adjacent the peripheral edge of the inner trim panels. The liners are provided with through-holes that are aligned with the push-in fasteners and the inboard surface of the door panels include through-holes which are aligned to receive the push-in fasteners provided on the inner trim panels. The inner trim panels are attached to the door panels by aligning and pushing the push-in fasteners on the inner trim panels into the through-holes in the door panels. The liners are positioned between the inner trim panels and door panels and held in position by the push-in fasteners. If, while aligning the inner trim panels and liners with the door panels, the adhesive bead(s) contact the door panel with the parts misaligned, it can become necessary to remove the liner from contact with the door panel and realign the inner trim panels and liners with the door panels. Such removal and realigning of the liners during the assembly of a vehicle door assembly can reduce production efficiency.

The present invention is directed to barrier panel for vehicle door panel assemblies that include engaging structures that are used for aligning and securing the barrier panels onto door panels. The present invention is further directed to methods and apparatuses for fabricating the engaging structures.

### DISCLOSURE OF THE INVENTION

According to various features, characteristics and embodiments of the present invention which will become apparent as the description thereof proceeds, the present invention provides a molding apparatus for forming engaging structures in vehicle door panels which engaging structures have base portions and over-hanging or under cut edges, the molding apparatus includes:

a panel mold base configured to form a vehicle door panel;

an engaging structure mold base coupled to the panel mold base for forming the base portion of a molded engaging structure; and

a movable tip coupled to the engaging structure mold base for movement between a first position for forming an over-hanging or under cut in the molded engaging structure and a second position for releasing the molded engaging structure from the molding apparatus.

The present invention further provides a method of molding an engaging structure in a vehicle door panel which involves the steps of:

a) providing a panel mold base configured to form a vehicle door panel;

b) providing an engaging structure mold base coupled to the panel mold base for forming the base portion of a molded engaging structure;

c) providing a movable tip coupled to the engaging structure mold base for movement between a first position for forming an over-hanging or under cut in the molded engaging structure and a second position for releasing the molded engaging structure from the molding apparatus;

d) positioning the movable tip in the first position;

e) molding a door panel with an engaging structure;

f) positioning the movable tip into the second position; and

g) removing the molding a door panel from the molding apparatus.

### BRIEF DESCRIPTION OF DRAWINGS

The present invention will be described with reference to the attached drawings which are given as non-limiting examples only, in which:

FIG. 1A is an elevational view of a door assembly showing a barrier panel according to one embodiment of the present invention in that is provided with engaging structures.

FIG. 1B is a sectional view of the door assembly of FIG. 1A taken along section lines I-I.

FIG. 1C is an enlarged view of the encircled portion of the door assembly illustrated in FIG. 1B.

FIG. 2 is a cross-sectional view of an engaging structure according to one embodiment of the present invention.

FIG. 3A, is a cross-sectional view of an engaging structure molding apparatus according to one embodiment of the present invention.

FIG. 3A₂ is a top view of the engaging structure molding apparatus of FIG. 3A₁.

FIG. 3A₃ is a planar front view of the engaging structure molding apparatus of FIG. 3A₁.

FIG. 3B₁ is a cross-sectional view of an engaging structure molding apparatus of FIG. 3B₁.

FIG. 3B₂ is a top view of the engaging structure molding apparatus of FIG. 3B₁.

FIG. 3B₃ is a planar rear view of the engaging structure molding apparatus of FIG. 3A₁.

FIG. 3C₁ is a side view of an engaging structure formed by the engaging structure molding apparatus of FIG. 3A₁.

FIG. 3C₂ is a top view of the engaging structure formed by the engaging structure molding apparatus of FIG. 3A₁.

FIG. 4A₁ is a cross-sectional view of an engaging structure molding apparatus according to one embodiment of the present invention.

FIG. 4A₂ is a top view of the engaging structure molding apparatus of FIG. 4A₁.

FIG. 4B₁ is a cross-sectional view of an engaging structure molding apparatus of FIG. 4B₁.

FIG. 4B₂ is a top view of the engaging structure molding apparatus of FIG. 4B₁.

FIG. 4C₁ is a side view of an engaging structure formed by the engaging structure molding apparatus of FIG. 4A₁.

FIG. 4C₂ is a top view of the engaging structure formed by the engaging structure molding apparatus of FIG. 4A₁.

FIG. 5A₁ is a cross-sectional view of an engaging structure molding apparatus according to one embodiment of the present invention.

FIG. 5A₂ is a top view of the engaging structure molding apparatus of FIG. 5A₁.

FIG. 5B₁ is a cross-sectional view of an engaging structure molding apparatus of FIG. 5B₁.

FIG. 5B₂ is a top view of the engaging structure molding apparatus of FIG. 5B₁.

FIG. 5B₃ is a cross-sectional view of an engaging structure molding apparatus of FIG. 5B₁.

FIG. 5C₁ is a side view of an engaging structure formed by the engaging structure molding apparatus of FIG. 5A₁.

FIG. 5C₂ is a top view of the engaging structure formed by the engaging structure molding apparatus of FIG. 5A₁.

### BEST MODE FOR CARRYING OUT THE INVENTION

The present invention is directed to water seals or barrier panels for vehicle door assemblies that include engaging structures that are formed integrally on the barrier panels by various molding techniques using molding apparatuses that are described herein. Reference herein to door panels encompasses both passenger doors, cargo doors and other closures which are susceptible to water leakage or might require thermal and/or acoustic insulation.

The engaging structures are formed so as to extend outward from an outboard side of the barrier panels and are configured with over-hanging or under cut edges that engage the edge or edges of openings formed in the inboard side of a door panel. The over-hanging or under cut edges can be formed from a variety of molding apparatuses which are discussed below and can have various shapes.

In addition to securing a door panel to a door panel, the engaging structures assist in aligning the barrier panel with the door panel by aligning the engaging structure, which protrude outward, with the contour or shape of the opening(s) formed in the inboard side of the door panel.

The barrier panels can be molded form any suitable material such as, for example, polyethylene, polystyrene, ABS plastics, polypropylene, thermal plastics, foamable plastics, etc.

The molding apparatuses herein described can be used in conjunction with vacuum molds, spray molds, injection molds, etc.

Features and characteristics of the present invention will be hereafter described with reference to the attached drawings which are provided as non-limiting examples only. Throughout the drawings, similar reference numerals are used to identify common elements when possible in order to simplify the description.

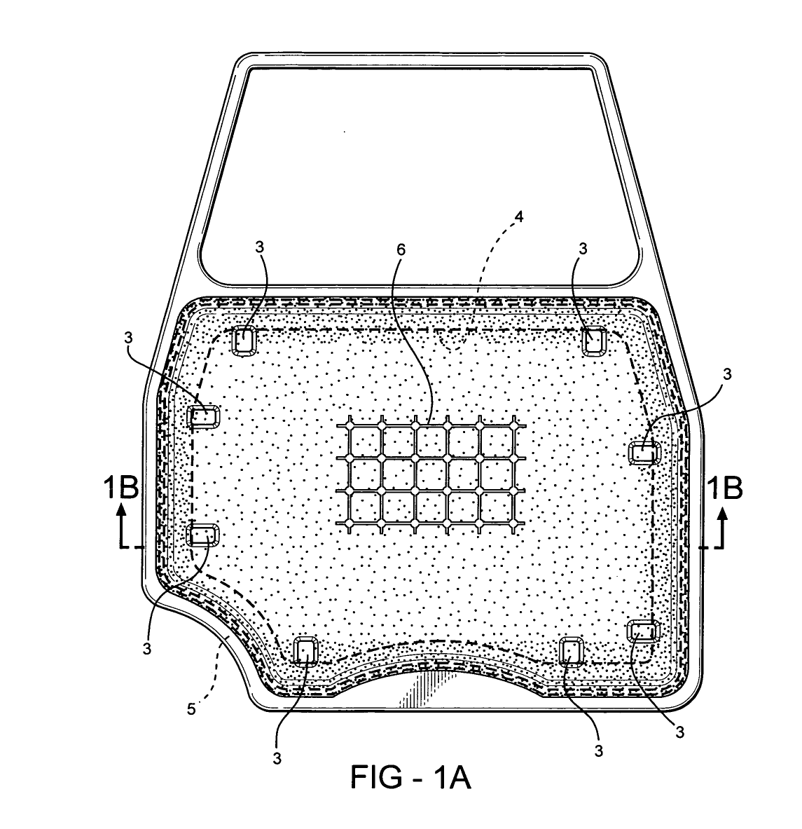

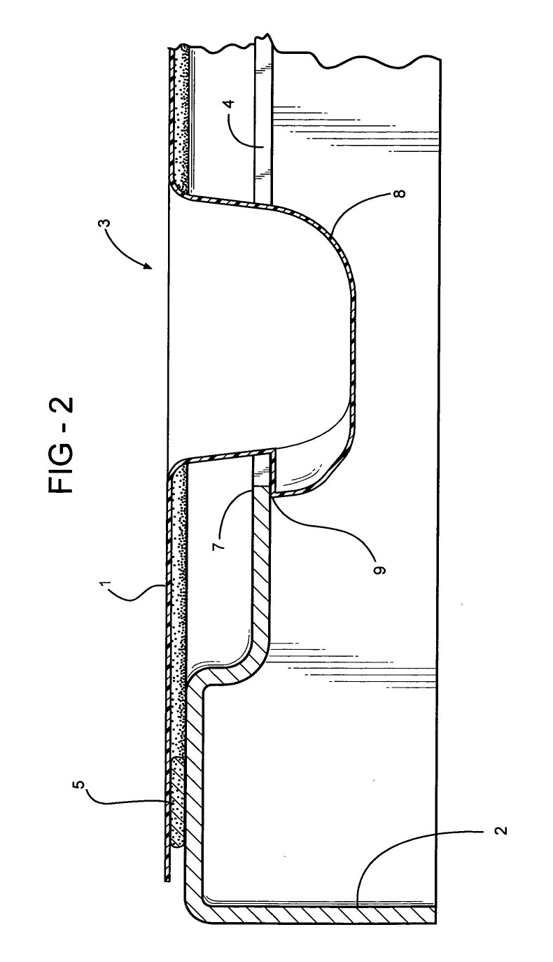

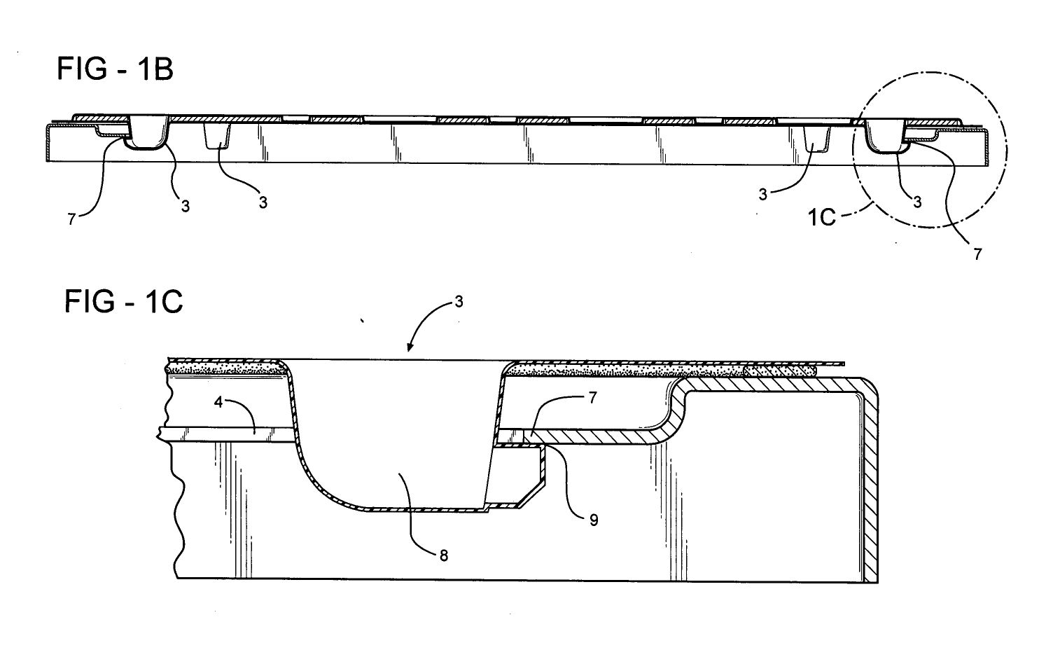

FIG. 1A is an elevational view of a barrier panel according to one embodiment of the present invention that is provide with engagement structures. The barrier panel which can comprise a single sheet or two or more sheets that are bonded together is generally identified by reference numeral 1 and is depicted as being attached to an exterior door panel 2. The barrier panel 1 includes a plurality of engaging structures 3 that are spaced apart around the exterior edges of the barrier panel 1. As shown in broken lines, the exterior door panel 2 includes an opening 4 into which the engaging structures 3 are received so as to align the barrier panel 1 with the exterior door panel 2 and secure the barrier panel 1 to the exterior door panel 2. Also shown in broken lines is a sealing element 5 that extends along the periphery of the barrier panel 1 so as to be positioned between the barrier panel 1 and the exterior door panel 2. The sealing element 5 can comprises a bead or beads of any conventional sealant/adhesive material or a compressible sealing element that can be molded into the outboard surface of the barrier panel 1.

The barrier panel 1 is depicted in FIG. 1A as having reinforcing structure in the central portion thereof generally shown as a grid structure 6 that can, for example be channels formed in one side of the barrier panel 1 so that the walls of the channels structurally reinforce the central portion of the barrier panel 1. Alternatively, when the barrier panel 1 is made from two or more sheets, the grid structure 6 represents channels in one or more of the individual sheets along the bottoms of which adjacent sheets are bonded together to structurally reinforce the barrier panel 1. Of course, in addition to a grid structure 6 that is illustrated, discrete channels, depressions, indentations, etc. could be used. When the barrier panel 1 comprises two or more sheets that are bonded together, areas in the space between adjacent sheets can be hollow or can contain or be filled with acoustic and/or thermal insulation materials such as noise absorbing materials or materials with low thermal conductivity.

FIG. 1B is a cross-sectional view of FIG. 1A taken along sectional lines II-II. FIG. 1B best shows the manner in which the engaging structures 3 extend into the opening 4 provided in the inboard side of the exterior door panel 2 so as to engage the edge 7 of the opening 4. As can be understood from FIGS. 1A and 1B the number and alignment of the engaging structures 3 can be varied as desired to accommodate a given door assembly, taking into consideration size, shape, etc. In some embodiments the door panel 2 may have several smaller openings rather than one opening 4 as shown. In such a case engagement structures 3 can be provided and aligned to engage the edges of some or all the openings.

FIG. 1C is an enlarged view of the encircled portion “C” of the door assembly illustrated in FIG. 1B. As can be seen best in FIG. 1C, the engagement structure 3 includes a base portion 8 and a molded under-cut or overhanging edge 9 (shown upside down) that engages the peripheral edge 7 of the opening 4 formed in the exterior door panel 2. This molded under-cut or overhanging edge 9 can have various shapes as will be understood as the description of the invention proceeds. FIG. 1C illustrates one configuration in which a bead of an adhesive and/or sealant material 5 is provided between the peripheral edge of the barrier panel 1 and the door panel 2 to provide a seal which prevents water or moisture from seeping therebetween.

FIG. 2 is a cross-sectional view of an engaging structure according to one embodiment of the present invention. The engagement structure 3 includes a base portion 8 that is generally hollow and formed as a depression or pocket that extends from the inboard surface of the barrier panel 1 inward toward the outboard surface. Near the bottom of the base portion 8 an under-cut or overhanging edge 9 (shown upside down) is provided which, as shown, is configured to engage the peripheral edge 7 of the opening 4 formed in the exterior door panel 2. In some embodiments, the engagement structures 3 could have base portions 8 that are elongated and configured, e.g. curved or angled, to be complementary to the shape of the edges of an opening 4 formed in a door panel 1 and could be provided with one or more under-cut or overhanging edge portions 9. For example, an engaging structure 3 having a right angled shape could be provided to align the barrier panel 1 with a corner of an opening 4 formed in a door panel 2 and could be provided with engaging structures 3 that engage the edges 7 of the opening 4 on either side of the corner.

The engaging structures 3 and particularly the under-cut or overhanging edges 9 of the engaging structures 3 can be formed with molding apparatuses which will now be described with reference to exemplary, non-limiting embodiments. The molding apparatuses herein described can be used in conjunction with vacuum molds, spray molds, injection molds, etc.

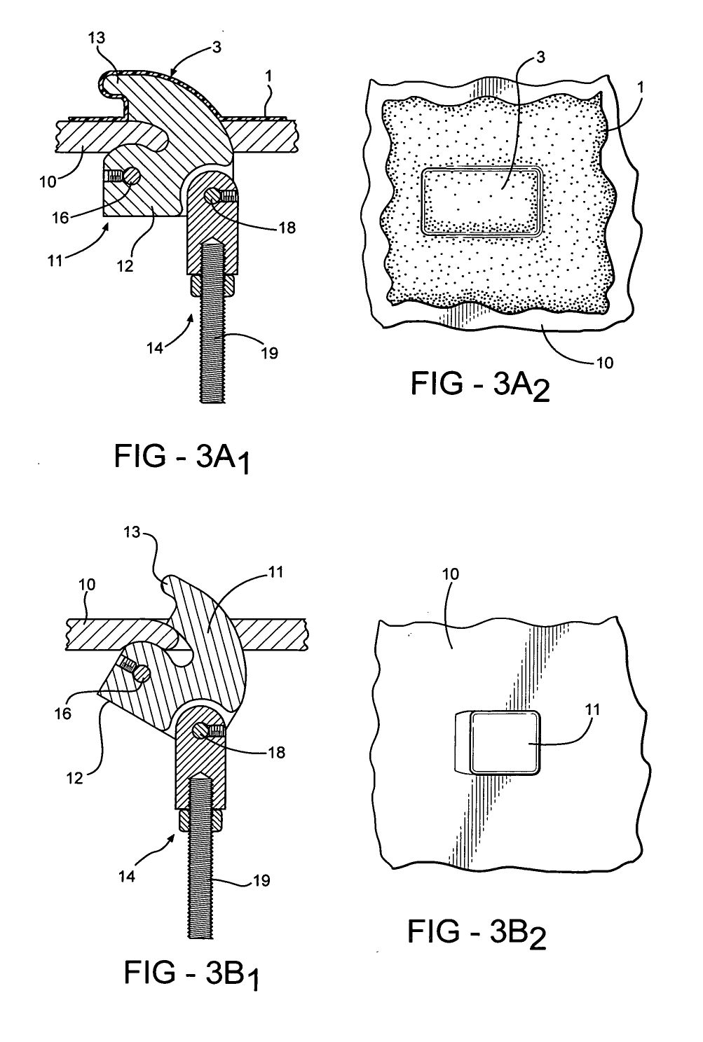

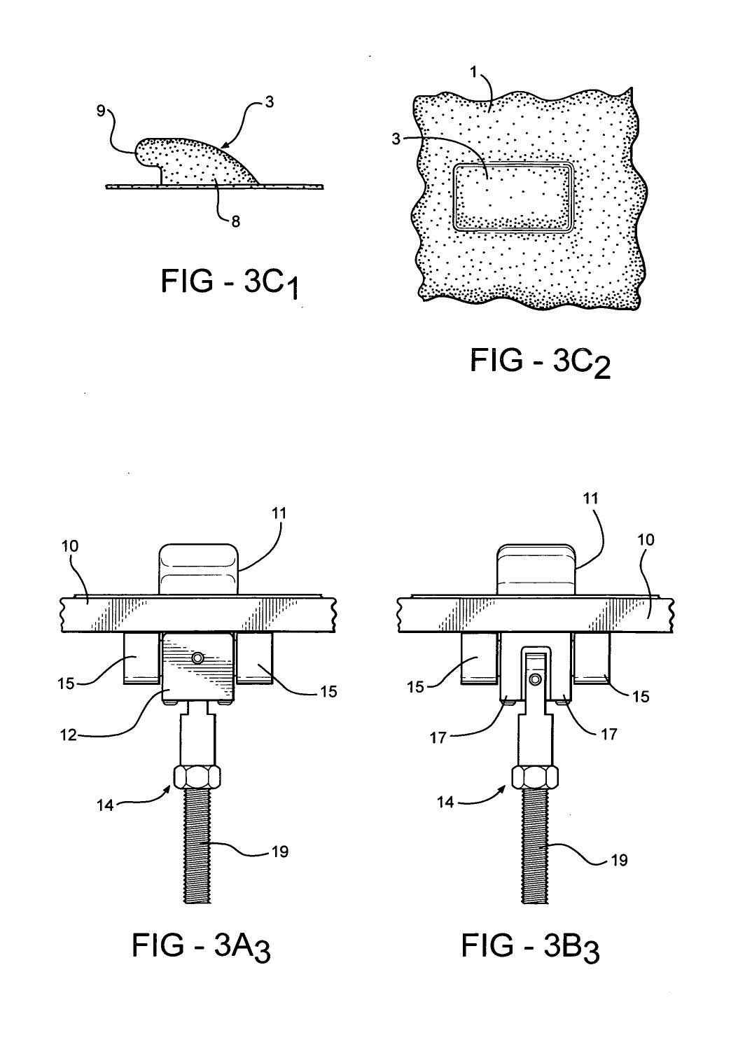

FIG. 3A₁ is a cross-sectional view of an engaging structure molding apparatus according to one embodiment of the present invention. The molding apparatus shown in FIG. 3A₁ is provided in the side of a larger mold structure such as a mold base 10 that is used to form the overall shape of a barrier panel 1. The molding apparatus of FIG. 3A₁ includes a pivotal pawl 11 that includes a base portion 12 that is pivotally coupled to the mold base 10 via a first pivotal connection and a tip 13 that are complementarily shaped to both the base portion 8 and under-cut or overhanging edge 9 of the resulting engagement structure 3 (FIG. 3C₁). The molding apparatus of FIG. 3A₁ further includes an actuator link 14 that is pivotally coupled to the base portion 12 of the pivotal pawl 11 by a second pivotal connection. FIG. 3A₁ depicts the molding apparatus with the pivotal pawl 11 in a position in which an engaging structure 3 will be formed in the barrier panel 1. FIG. 3A₂ is a top view of the engaging structure molding apparatus of FIG. 3A₁ and depicts the generally rectangular shape that will be transferred into the resulting shaped engagement structure 3.

FIG. 3B₁ is a cross-sectional view of an engaging structure molding apparatus of FIG. 3B₁. In FIG. 3B₁ the actuator link 14 has been pulled downward, thereby pivotal pawl 11 into a position in which the tip 13 of the pivotal pawl 11 that is used to form the under-cut or overhanging edge 9 in the resulting engagement structure 3 is pivotally retracted enough so that the molded barrier panel 1 having the engagement structure 3 molded therein can be removed from the mold. That is, the tip 13 of the pivotal pawl 11 has been retracted in FIG. 3B₁ so as to clear the under-cut or overhanging edge 9 of the molded engagement structure 3. FIG. 3B₂ is a top view of the engaging structure molding apparatus of FIG. 3B₁ which shows how the pivoting of the pivotal pawl 11 effectively retracts or shortens the length of the part of the pivotal pawl 11 that extends through the mold base 10.

FIG. 3A₃ is a planar front view of the engaging structure molding apparatus of FIG. 3A₁. FIG. 3B₃ is a planar rear view of the engaging structure molding apparatus of FIG. 3A₁.

As shown in FIGS. 3A₃ and 3B₃, the base portion 12 of the pivotal pawl 11 is pivotally connected between two spaced apart pivot supports 15 that are coupled to the bottom of the mold base 10 and a pivot pin 16 (FIG. 3A₁) that passes through the base portion 12 of the pivotal pawl 11 and has opposite ends that extend into or pass through one or both of the pivot supports 15. The rear portion of the base portion 12 of the pivotal pawl 11 includes a central cutout area that forms a yoke structure having two arms 17 between which the end of the actuator link 14 is pivotally coupled by a pivot pin 18 (FIG. 3A₁) that passes through the end of the actuator link 14 and has opposite ends that extend into or pass through one or both of the arms 17 formed at the rear of the base portion 12 of the pivotal pawl 11. In alternative embodiments, the front of the of the base portion 12 of the pivotal pawl 11 could be formed with a yoke structure that cooperates with a single pivot support provided on the bottom of the mold base 10 or the actuator link 14 could be provided with a yoke structure that cooperates with a single pivot support provided on the rear of the base portion 12 of the pivotal pawl 11. Other pivotal constructions/structures can also be used.

The actuator link 14 is depicted as being coupled to a rod 19 which in turn is coupled to a suitable actuator by which the actuator link 14 and pivotal pawl 11 can be moved between the positions depicted in FIGS. 3A₁ and 3B₁ using any suitable hydraulic, pneumatic/vacuum, electrical, mechanical means. Moreover the movement of the actuator link 14 can be automated with the overall molding process that forms the barrier panel 1. In the case of a vacuum molding process the pivotal pawl 11 can be pivoted into the position depicted in FIG. 3A₁ after the barrier panel 1 is pulled down against the mold base. In the case of an injection or spray molding process the pivotal pawl 11 can be provided in the position depicted in FIG. 3A₁ before the material for producing the barrier panel 1 is supplied into the mold. Those skilled in the art can easily adapt and use the molding apparatuses of the present invention in other molding processes.

FIG. 3C₁ is a side view of an engaging structure formed by the engaging structure molding apparatus of FIG. 3A₁. FIG. 3C₂ is a top view of the engaging structure formed by the engaging structure molding apparatus of FIG. 3A₁. As shown, the engaging structure 3 includes the base 8 and under-cut or overhanging 9 portions that are discussed above.

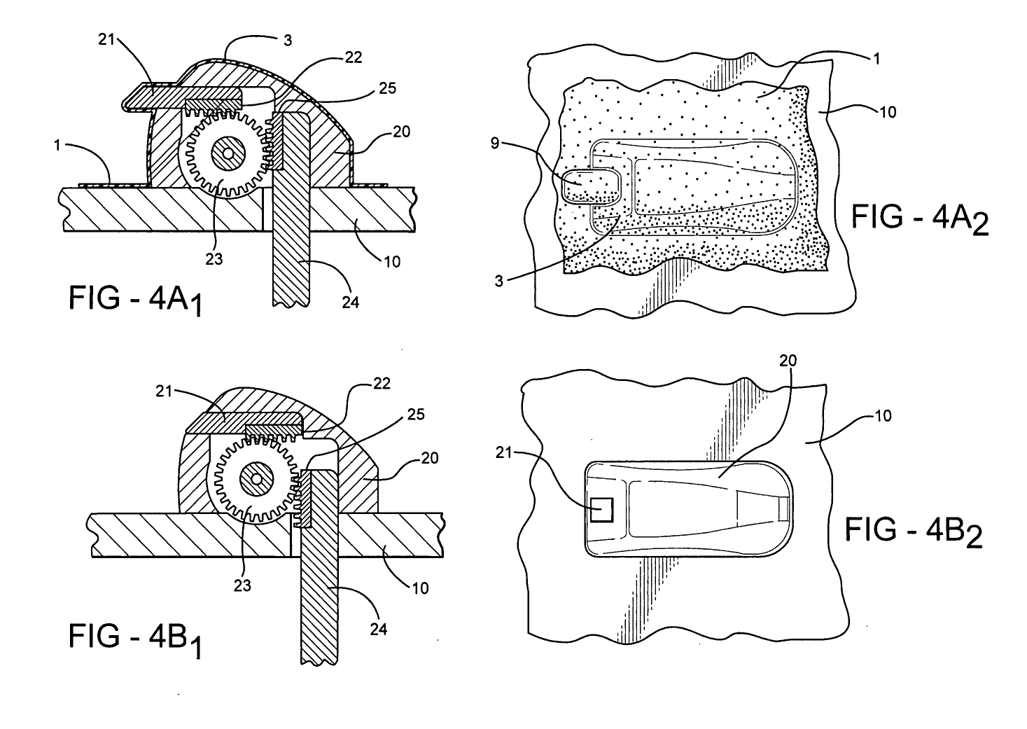

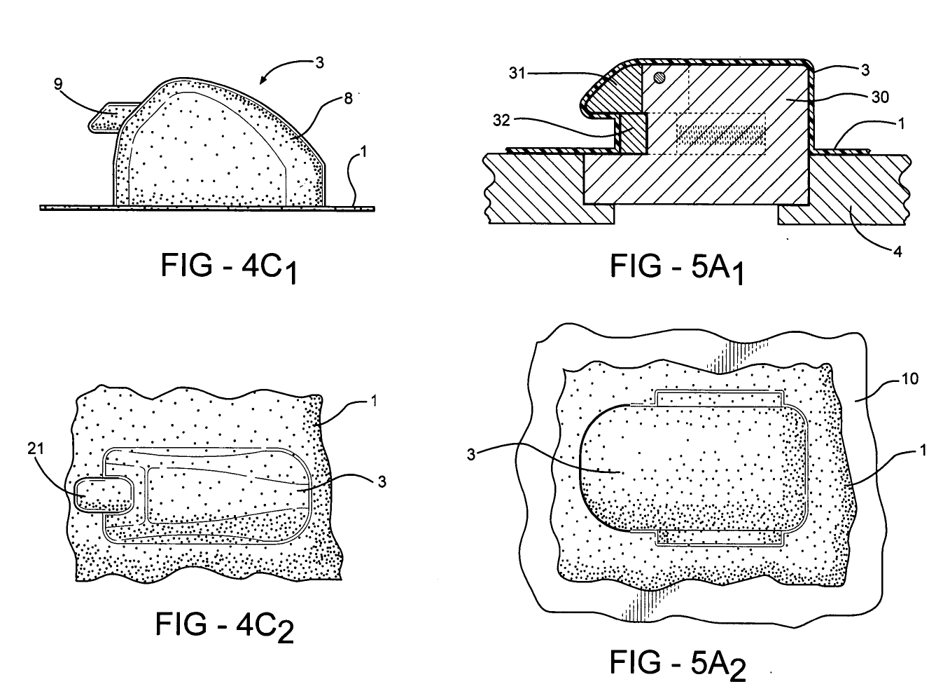

FIG. 4A₁ is a cross-sectional view of an engaging structure molding apparatus according to one embodiment of the present invention. The molding apparatus depicted in FIG. 4A₁ includes a base portion 20 that is provided in a fixed position with respect to the mold base 10. In addition, the molding apparatus includes a retractable tip 21 that can be extended from or retracted into the mold base 20.

According to one embodiment that is illustrated, the retractable tip 21 is provided with teeth 22 along a proximal end thereof which teeth 22 are configured to engage and cooperate with a toothed wheel or gear 23. The toothed wheel or gear 23 is in turn coupled to an actuator link 24 that is provided with teeth 25 that are configured to engage and cooperate with a toothed wheel or gear 23. In other embodiments two or more toothed wheels or gears could be used which are coupled together on a common axel.

FIG. 4A₁ depicts the molding apparatus with the retractable tip 21 in a position in which an engaging structure 3 will be formed in the barrier panel 1. FIG. 4A₂ is a top view of the engaging structure molding apparatus of FIG. 4A₁ and depicts the generally rectangular shape that will be transferred into the resulting shaped engagement structure 3.

FIG. 4B₁ is a cross-sectional view of an engaging structure molding apparatus of FIG. 4A₁. In FIG. 4B₁ the actuator link 24 has been pushed upward, thereby rotating toothed wheel or gear 23 and causing the distal end of retractable tip 21 to retract into the mold base 20 in a position in which the distal end of the retractable tip 21 is retracted enough so that the molded barrier panel 1 having the engagement structure 3 molded therein can be removed from the mold. That is, the distal end of the retractable tip 21 has been retracted in FIG. 4B₁ so as to clear the under-cut or overhanging edge 9 of the molded engagement structure 3. FIG. 4B₂ is a top view of the engaging structure molding apparatus of FIG. 3B₁ which shows how the retractable tip 21 effectively retracts so as not to extend beyond the mold base 10.

In the case of a vacuum molding process the retractable tip 2can be moved into the position depicted in FIG. 4A₁ after the barrier panel 1 is pulled down against the mold base. In the case of an injection or spray molding process the retractable tip 21 can be provided in the position depicted in FIG. 4A₁ before the material for producing the barrier panel 1 is supplied into the mold. Those skilled in the art can easily adapt and use the molding apparatuses of the present invention in other molding processes.

FIG. 4C₁ is a side view of an engaging structure formed by the engaging structure molding apparatus of FIG. 4A₁. FIG. 4C₂ is a top view of the engaging structure formed by the engaging structure molding apparatus of FIG. 4A₁. As shown, the engaging structure 3 includes the base 8 and under-cut or overhanging 9 portions that are discussed above.

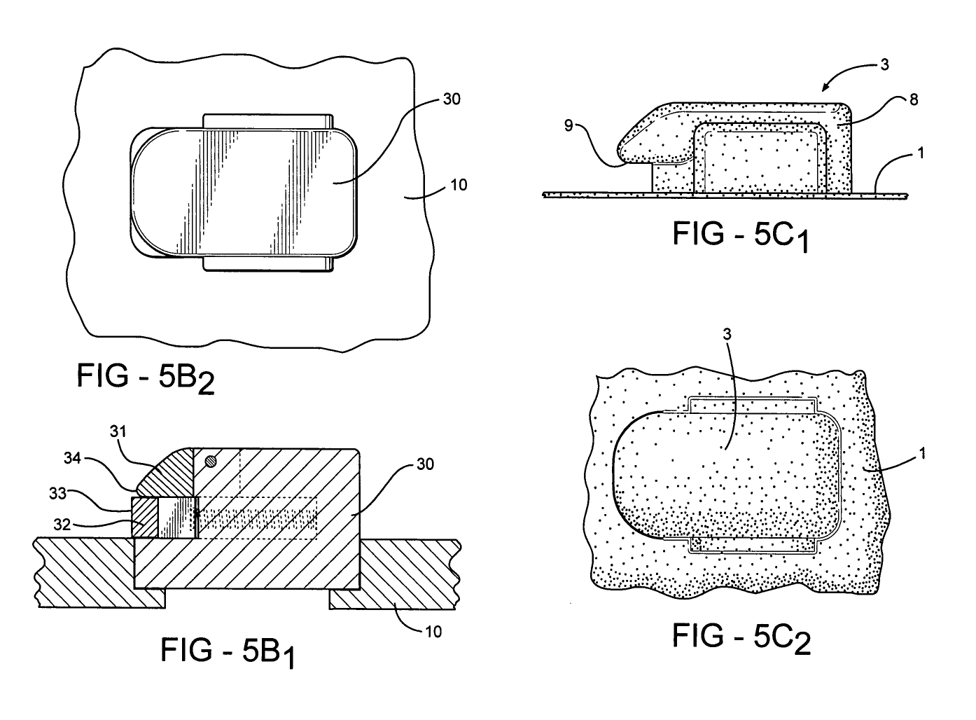

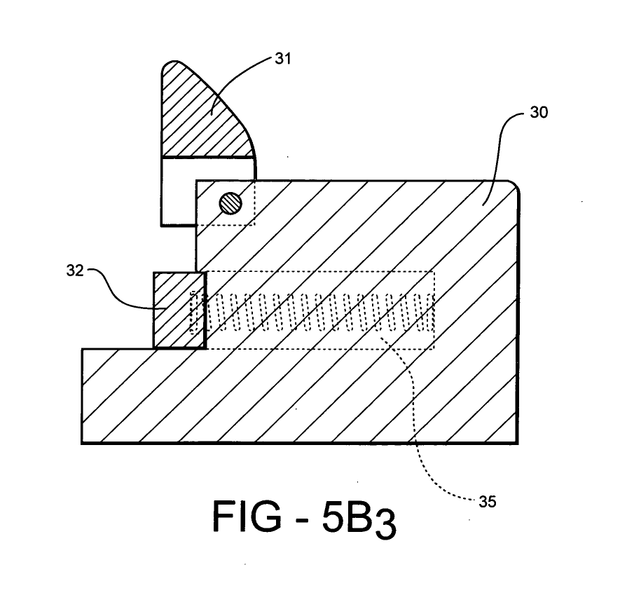

FIG. 5A₁ is a cross-sectional view of an engaging structure molding apparatus according to one embodiment of the present invention. FIG. 5A₂ is a top view of the engaging structure molding apparatus of FIG. 5A₁. The molding apparatus depicted in FIG. 5A₁ includes a base portion 30 that is provided in a fixed position with respect to the mold base 10. In addition, the molding apparatus includes pivotal tip 31 and a retractable wall portion 32 beneath the pivotal tip 31 that can be used to form an undercut or over hanging edge 9 in a molded engaging structure 3 as discussed in more detail below. The pivotal tip 31 is configured to define the final shape of the undercut or over hanging edge 9 of a molded engaging structure 3 when positioned in a first position (shown in FIG. 5A₁), and is configured to clear a molded engaging structure 3 that is being withdrawn from the mold when positioned in a second position (shown in FIG. 5B₃).

FIG. 5B₁ is a cross-sectional view of an engaging structure molding apparatus of FIG. 5B₁. FIG. 5B₂ is a top view of the engaging structure molding apparatus of FIG. 5B₁. In FIG. 5B₁ the retractable wall portion 32 of the molding apparatus is depicted as being in a first position in which the leading face 33 of the retractable wall portion 32 is substantially lined up or is flush with the leading edge 34 of the pivotal tip 31. This is the initial position of the retractable wall portion 32 and the pivotal tip 31 at the beginning of a vacuum molding process.

Once a sheet of moldable material is heated near its melting temperature and pulled against the mold base 10 by vacuum, the retractable wall portion 32 of the molding apparatus is moved from the position depicted in FIG. 5B₁ to the position depicted in FIG. 5A₁. This movement of the retractable wall portion 32 creates a vacuum that pulls or draws the heated moldable material beneath the pivotal tip 31 thereby forming the undercut or over hanging edge 9 of the resulting engagement structure 3. Movement of the retractable wall portion 32 can be provided by any suitable hydraulic, pneumatic/vacuum, electrical, mechanical means which are generally identified by reference numeral 35 and shown schematically.

In order to remove the molded engaging structure from the molding apparatus, the pivotal tip 31 moves from the position depicted in FIG. 5A₁ into the position depicted in FIG. 5B₃ as the molded engaging structure 3 is removed from the mold. As the pivotal tip 31 pivots from the position depicted in FIG. 5A₁ into the position depicted in FIG. 5B₃ it moves out of the path of the molded engaging structure 3 so as to clear the molded engaging structure 3. The pivotal tip 31 can be reset to the position depicted in FIG. 5A₁ for a subsequent molding process manually or under the influence of gravity or could be provided with a simple return spring (not shown).

FIG. 5B₃ is a cross-sectional view of an engaging structure molding apparatus of FIG. 5B₁. In FIG. 5B₃ the pivotal tip 31 of the molding apparatus is shown in its second position in which it clears a molded engaging structure 3 that is being withdrawn from the mold. As can be understood from viewing FIGS. 5A₁ and 5B₂, after an engaging structure 3 has been molded and while it is being removed from (lifted off) the mold, the under-cut or overhanging edge 9 of the engaging structure 3 lifts and pivots the pivotal tip 31 from the first position (shown in FIG. 5A₁) into the second position (shown in FIG. 5B₂) thereby allowing the molded engaging structure 3 to clear and be removed from the mold. It is to be understood that the figures are illustrative and that the pivotal tip 31 can having other shapes than that illustrated, including a more rounded rather than a tapered tip. In the case of an injection or spray molding process the retractable wall portion 32 can be held in the position depicted in FIG. 5A₁ before the material for producing the barrier panel 1 is supplied into the mold. Those skilled in the art can easily adapt and use the molding apparatuses of the present invention in other molding processes.

FIG. 5C₁ is a side view of an engaging structure formed by the engaging structure molding apparatus of FIG. 5A₁. FIG. 5C₂ is a top view of the engaging structure formed by the engaging structure molding apparatus of FIG. 5A₁. As shown, the engaging structure 3 includes the base 8 and under-cut or overhanging 9 portions that are discussed above.

Although the present invention has been described with reference to particular means, materials and embodiments, from the foregoing description, one skilled in the art can easily ascertain the essential characteristics of the present invention and various changes and modifications can be made to adapt the various uses and characteristics without departing from the spirit and scope of the present invention as described above and the attached claims.

What is claimed is:

1. A molding apparatus for forming engaging structures in vehicle door panels which engaging structures have base portions and over-hanging or under cut edges, the molding apparatus comprising:
a panel mold base configured to form a vehicle door panel;
an engaging structure mold base coupled to the panel mold base for forming the base portion of a molded engaging structure; and
a movable tip coupled to the engaging structure mold base for movement between a first position for forming an over-hanging or under cut in the molded engaging structure and a second position for releasing the molded engaging structure from the molding apparatus.

2. A molding apparatus for forming engaging structures in vehicle door panels according to claim 1, wherein the movable tip moves linearly between the first position and the second position.

3. A molding apparatus for forming engaging structures in vehicle door panels according to claim 1, wherein the movable tip pivots between the first position and the second position.

4. A molding apparatus for forming engaging structures in vehicle door panels according to claim 1, wherein the movable tip retracts into the engaging structure mold base when positioned in the second position.

5. A molding apparatus for forming engaging structures in vehicle door panels according to claim 1, wherein the movable tip is fixed with respect to the engaging structure mold base.

6. A molding apparatus for forming engaging structures in vehicle door panels according to claim 1, wherein the movable tip moves with respect to the engaging structure mold base into the first position and the second position.

7. A molding apparatus for forming engaging structures in vehicle door panels according to claim 1, wherein both the engaging structure mold base and the movable tip move with respect to the mold base into the first position and the second position.

8. A molding apparatus for forming engaging structures in vehicle door panels according to claim 1, further comprising an actuator link coupled to the movable tip for moving the movable tip between the first position and the second position.

9. A molding apparatus for forming engaging structures in vehicle door panels according to claim 8, wherein the actuator link is pivotally coupled to the movable tip.

10. A molding apparatus for forming engaging structures in vehicle door panels according to claim 8, wherein the actuator link is linearly coupled to the movable tip.

11. A molding apparatus for forming engaging structures in vehicle door panels according to claim 10, wherein the actuator link is coupled to the movable tip by a toothed wheel.

12. A molding apparatus for forming engaging structures in vehicle door panels according to claim 8, further comprising at least one of a hydraulic, pneumatic/vacuum, electrical, mechanical actuator for moving the actuator link

13. A molding apparatus for forming engaging structures in vehicle door panels according to claim 1, wherein the engaging structure mold base comprises a movable wall portion beneath the movable tip.

14. A molding apparatus for forming engaging structures in vehicle door panels according to claim 1, wherein the movable tip comprises two or more movable tips.

15. A method of molding an engaging structure in a vehicle door panel which comprises the steps of:
a) providing a panel mold base configured to form a vehicle door panel;
b) providing an engaging structure mold base coupled to the panel mold base for forming the base portion of a molded engaging structure;
c) providing a movable tip coupled to the engaging structure mold base for movement between a first position for forming an over-hanging or under cut in the molded engaging structure and a second position for releasing the molded engaging structure from the molding apparatus;
d) positioning the movable tip in the first position;
e) molding a door panel with an engaging structure;
f) positioning the movable tip into the second position; and
g) removing the molding a door panel from the molding apparatus.

16. A method of molding an engaging structure in a vehicle door panel according to claim 15, further comprising providing the engaging structure mold base with a movable wall portion beneath the movable tip and, between steps d) and f), moving the movable wall portion to form the over-hanging or under cut in the engaging structure.

17. A method of molding an engaging structure in a vehicle door panel according to claim 15, wherein the movable tip is moved linearly between the first position and the second position.

18. A method of molding an engaging structure in a vehicle door panel according to claim 15, wherein the movable tip is pivoted between the first position and the second position.

19. A method of molding an engaging structure in a vehicle door panel according to claim 15, wherein the movable tip moves with respect to the engaging structure mold base into the first position and the second position.

20. A method of molding an engaging structure in a vehicle door panel according to claim 15, wherein both the engaging structure mold base and the movable tip move with respect to the mold base into the first position and the second position.
